(19) United States
(12) Patent Application Publication
(10) Pub. No.: US 2014/0291110 A1
(43) Pub. Date: Oct. 2, 2014

(54) BANKNOTE PROCESSING DEVICE

(71) Applicant: Oki Electric Industry Co., Ltd., Tokyo (JP)

(72) Inventors: Akira Adachi, Tokyo (JP); Akihiro Sasaki, Tokyo (JP)

(73) Assignee: OKI ELECTRIC INDUSTRY CO., LTD., Tokyo (JP)

(21) Appl. No.: 14/362,597

(22) PCT Filed: Nov. 1, 2012
(86) PCT No.: PCT/JP2012/078380

§ 371 Date: Jun. 3, 2014

(30) Foreign Application Priority Data
Dec. 5, 2011 (JP) 2011-265561

(51) Int. Cl. G07D 11/00

(52) U.S. Cl. CPC G07D 11/0018; G07D 11/0081
USPC 194/206

(57) ABSTRACT

The banknote processing device includes plural dispensing ports that dispense banknotes; a banknote classification section that classifies banknotes; and a controller that selects a conveyance destination of banknotes classified by the banknote classification section from the plural dispensing ports, and effects control to convey the banknotes to a selected dispensing port.

### TECHNICAL FIELD

The present invention relates to a banknote processing device.

### BACKGROUND ART

Recently, cash processing devices, typified by service counter cash processing machines installed at service counters in branches of financial institutions, are being employed, for example, in pay-in and pay-out transactions with banknotes and coins, as well as for check counting. A cashier is able to perform, for example, pay-in and pay-out transactions by performing various operations on an operation section of the cash processing device, or on a reception terminal (information processing device) connected to the cash processing device.

Such a cash processing device installed between two tellers (operators) enables pay-in and pay-out of banknotes and coins. Patent Document 1 (Japanese Patent Application Laid-Open (JP-A) No. 2001-93022) discloses a circulation type currency processor that, when the circulation type currency processor is installed between two tellers and used, has a structure in which the layout, such as of a banknote input port, is changed to enable easy operation by tellers from either the right or left.

Conventionally, as illustrated in Patent Document 1 (JP-A No. 2001-93022), a cash processing machine is provided with two banknote handling ports.

### DISCLOSURE OF INVENTION

### Technical Problem

However, one of the two banknote handling ports hitherto provided is a banknote input port, and the other is a banknote output port. There has accordingly been an issue that, when dispensing banknotes, they are all dispensed from the same output port irrespective of the denomination and state (quality) of banknotes.

Specifically, when, for example, selecting and dispensing banknotes by denomination, such as during check-counting, if there are plural banknote output ports then this should enable banknotes to be paid out according to denomination, thereby improving convenience.

Moreover, in pay-in transactions, banknotes that are classified as abnormal (determined to be rejected) by the banknote classification section are all dispensed from the single banknote output port irrespective of the cause of rejects. It is accordingly not known whether they have been rejected, for example, as being damaged notes or notes with abnormal travel, or whether they have been rejected as being counterfeit notes.

Further, even if the capacity of a banknote output port is 200 notes or greater, since there is a tendency to pay out notes in units of 100 notes, which may be easily countable, when a cashier is passing banknotes to a customer, banknote output ports of large capacity are, in practice, over specification.

Thus, in consideration of the above circumstances, an object of the present invention is to provide a novel and improved banknote processing device that enables banknotes to be selectively dispensed from plural output ports.

### Solution to Problem

In order to address the above issues, an aspect of the present invention provides a banknote processing device including: plural dispensing ports that dispense banknotes; a banknote classification section that classifies banknotes; and a controller that selects a conveyance destination of banknotes classified by the banknote classification section from the plural dispensing ports, and effects control to convey the banknotes to a selected dispensing port.

The controller may select the conveyance destination of the banknotes from the plural dispensing ports according to the number of banknotes to be dispensed.

The controller may select the conveyance destination of the banknotes from the plural dispensing ports according to the denomination of banknotes to be dispensed.

The banknote classification section may classify the banknotes according to physical condition; and the controller, during a check counting operation, may select the conveyance destination of the banknotes from the plural dispensing ports according to the physical condition of banknotes to be dispensed.

The banknote classification section may classify the banknotes according to authenticity; and the controller, during a check counting operation, may select the conveyance destination of the banknotes from the plural dispensing ports according to the authenticity of banknotes to be dispensed.

The banknote classification section may classify the banknotes according to a cause of rejection; and the controller, during a check counting operation, may select the conveyance destination of the banknotes from the plural dispensing ports according to the cause of rejection of banknotes to be dispensed.

The banknote classification section may classify the banknotes according to authenticity and physical condition; and the controller, during a pay-in transaction, may effect conveyance control to deliver banknotes classified by the banknote classification section as normal to a banknote storage section, and to deliver banknotes classified by the banknote classification section as counterfeit notes or damaged notes to a conveyance destination selected from the plural dispensing ports in accordance with the classification result.

The controller may effect conveyance control so as to utilize a dispensing port other than a dispensing port detected to have a malfunction, if one or more dispensing ports of the plural dispensing ports have been detected to have a malfunction.

The plural dispensing ports may be detachable.

The banknote processing device may be connected to plural reception terminals; and the controller may receive instructions for a pay-in or pay-out transaction, a check counting operation, or a dispensing port retrieval operation from the plural reception terminals, and may select the conveyance destination of the banknotes from the plural dispensing ports in accordance with the reception terminal from which the instructions have been received.

### Advantageous Effects of Invention

As explained above, the present invention enables selective dispensing of banknote from plural dispensing ports.

### BRIEF DESCRIPTION OF DRAWINGS

FIG. 1 is an explanatory diagram illustrating a configuration of a banknote processing system according to an exemplary embodiment of the present invention.

FIG. 2 is a diagram illustrating an internal structure of a banknote processing device according to an exemplary embodiment of the present invention.

FIG. 3 is a block diagram illustrating a functional configuration of a banknote processing device according to an exemplary embodiment of the present invention.

FIG. 4 is a flow chart illustrating processing of dispensing banknotes in batches of a number of notes according to a first exemplary embodiment.

FIG. 5 is a diagram illustrating the conveyance path of banknotes in output or output port retrieval according to the first exemplary embodiment.

FIG. 6 is a diagram illustrating a conveyance path of banknotes in a check counting operation according to the first exemplary embodiment.

FIG. 7 is a flow chart illustrating processing for dispensing banknotes by denomination according to a second exemplary embodiment.

FIG. 8 is a flow chart illustrating processing for dispensing banknotes in batches of a number of notes, and by denomination, according to a modified example of the second exemplary embodiment.

FIG. 9 is a flow chart illustrating processing for conveying banknotes according to their physical condition according to a third exemplary embodiment.

FIG. 10 is a diagram illustrating a conveyance path during conveying banknotes according to their physical condition according to the third exemplary embodiment.

FIG. 11 is a flow chart illustrating processing for dispensing banknotes according to their authenticity according to a fourth exemplary embodiment.

FIG. 12 is a flow chart illustrating conveying processing of banknotes in a pay-in transaction according to a fifth exemplary embodiment.

FIG. 13 is a flow chart illustrating conveying processing of banknotes in a RJ cause sort mode of check counting operation according to a sixth exemplary embodiment.

FIG. 14 is an explanatory diagram of a case in which a banknote processing device 10 is shared according to a seventh exemplary embodiment.

FIG. 15 is a flow chart illustrating processing for dispensing banknotes according to reception terminals according to the seventh exemplary embodiment.

### BEST MODE FOR CARRYING OUT THE INVENTION

Detailed explanation follows regarding a preferable exemplary embodiment of the present invention, with reference to the accompanying drawings. Note that in the present specification and in the drawings, components with effectively the same function and configuration as each other are allocated the same reference numerals, and redundant explanation thereof is omitted.

### 1. BANKNOTE PROCESSING SYSTEM OUTLINE

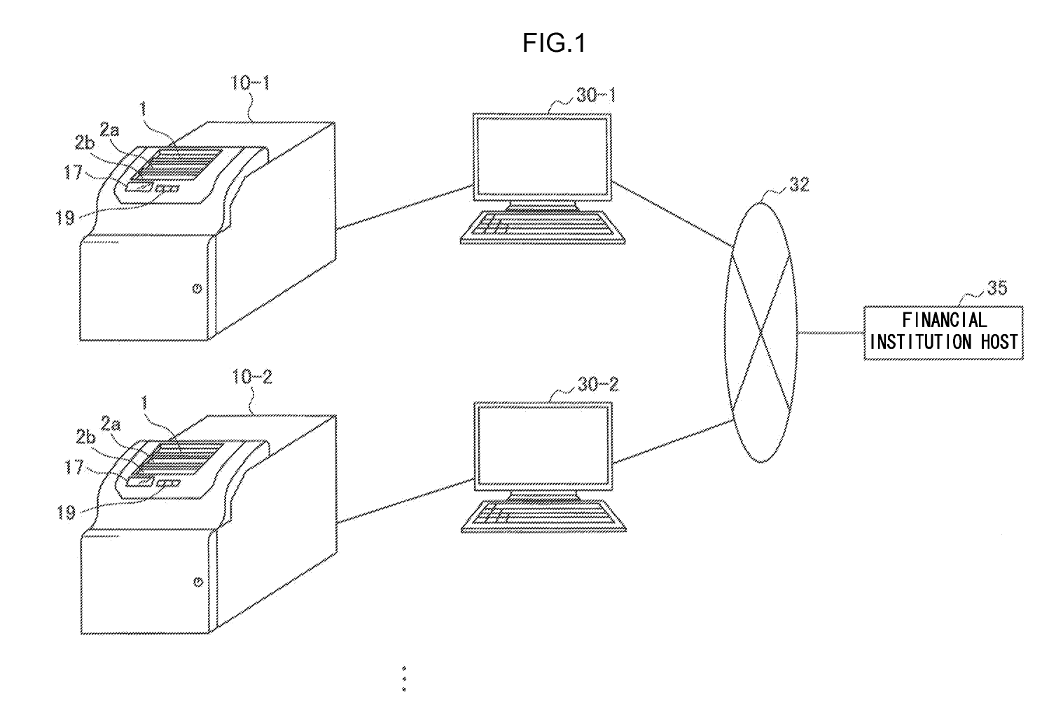

First, explanation is given regarding a banknote processing system according to an exemplary embodiment of the present invention, with reference to FIG. 1.

FIG. 1 is an explanatory diagram illustrating a configuration of a banknote processing system according to an exemplary embodiment of the present invention. As illustrated in FIG. 1, the banknote processing system includes a banknote processing device 10-1, a banknote processing device 10-2, a reception terminal 30-1 that is connected to the banknote processing device 10-1, a reception terminal 30-2 that is connected to the banknote processing device 10-2, a dedicated network 32, and a financial institution host 35. Since the banknote processing device 10-1 and the banknote processing device 10-2 illustrated in FIG. 1 are substantially the same as each other, reference is made below to the banknote processing device 10 when there is no need to discriminate individually. Further, since the reception terminal 30-1 and the reception terminal 30-2 illustrated in FIG. 1 are substantially the same as each other, reference is made below to the reception terminal device 30 when there is no need to discriminate individually. In the example illustrated in FIG. 1, a single reception terminal 30 is connected to each of the banknote processing devices 10. However, the banknote processing system of the present exemplary embodiment is not limited thereto, and plural reception terminals 30 may be connected to each of the banknote processing devices 10. The respective reception terminals 30 are connected to the financial institution host 35 via the dedicated network 32.

The banknote processing device 10 is a staff-operated terminal that performs financial transactions, for example, under the operation of a cashier, such as at a service counter of a financial institution. The banknote processing device 10 is installed for example in a branch of a financial institution.

As illustrated in FIG. 1, the banknote processing device 10 further includes a input port 1 into which banknotes are inserted, output ports 2a, 2b that dispense banknotes, a display section 17, and an operation section 19. The display section 17 displays a menu screen and a processing result screen. The display section 17 is, for example, implemented by a Cathode Ray Tube (CRT) display device, a Liquid Crystal Display (LCD) device, or an Organic Light Emitting Diode (OLED) device. The operation section 19 detects operation by a cashier. The operation section 19 is implemented by, for example, buttons, switches, or a touch panel. Note that FIG. 1 illustrates a case in which a display function and an operation function are provided separately to one another, however the banknote processing device 10 of the present exemplary embodiment is not limited thereto, and the display function and operation function may be integrated together. The banknote processing device 10 may also display a guidance screen that guides operation by the cashier on a display section including an operation detection function.

The input port 1 is an insertion port into which banknotes are inserted by the cashier. The input port 1 may be provided with a shutter (not illustrated in the drawings) that opens and closes an opening portion. The input port 1 moreover includes a separating function for separating banknotes inserted as a bundle, to be fed out one note at a time.

The output ports 2a, 2b are dispensing ports that dispense banknotes to be collected by the cashier. The output ports 2a, 2b may each be provided with a shutter (not illustrated in the drawings) that opens and closes an opening portion. Each of the output ports 2a, 2b also includes a stacking function for stacking dispensed banknotes. The output ports 2a, 2b according to the present exemplary embodiment have, for example, a capacity capable of stacking 100 banknotes. Note that although there are two of the output ports provided in the example illustrated in FIG. 1, the present exemplary embodiment is not limited thereto, and, for example, three or more output ports may be provided. The present exemplary embodiment enables improved convenience by selectively dispensing banknotes from such plural output ports. Control for selectively dispensing banknotes from the plural output ports is explained in detail later under “3. Exemplary Embodiments”.

The reception terminals 30 are data processing devices that perform reception operations. The reception terminals 30 have a wired or wireless connection to the banknote processing devices 10, and transmit to the banknote processing devices 10 instructions to perform a processing mode selected by the cashier (such as a pay-in or pay-out transaction, output port retrieval, or check counting). The banknote processing device 10 of the present exemplary embodiment may therefore be operated by using a data processing device connected to the banknote processing device 10, as well as by using the operation section 19 provided to the banknote processing device 10.

The dedicated network 32 is a network belonging to a financial institution that includes a branch, or plural branches, installed with the reception terminals 30. The dedicated network 32 is configured by, for example, an Internet Protocol-Virtual Private Network (IP-VPN). The financial institution host 35 is able to communicate with plural reception terminals 30 over the dedicated network 32.

The financial institution host 35 controls various transactions by communicating with the reception terminals 30 over the dedicated network 32, or by communicating with the banknote processing devices 10 through the reception terminals 30. For example, the financial institution host 35 performs customer verification and financial transactions (account transaction processing) such as pay-in or bank transfers instructed by the cashier. The financial institution host 35 also manages customer information (account ledgers) including, for example, an account number, personal identification number, name, address, age, date of birth, telephone number, occupation, family structure, income and balance amount.

An exemplary embodiment of the present invention relates to each of the banknote processing devices 10 included in the banknote processing system described above, and in particular relates control of selectively dispensing banknotes from the plural output ports of the banknote processing device 10. After first explaining the configuration and basic operation of the banknote processing device 10, more detailed explanation will then be given regarding banknote dispensing control according to an exemplary embodiment of the present invention.

### 2. CONFIGURATION AND BASIC OPERATION OF BANKNOTE PROCESSING DEVICE 10

2-1. Internal Structure

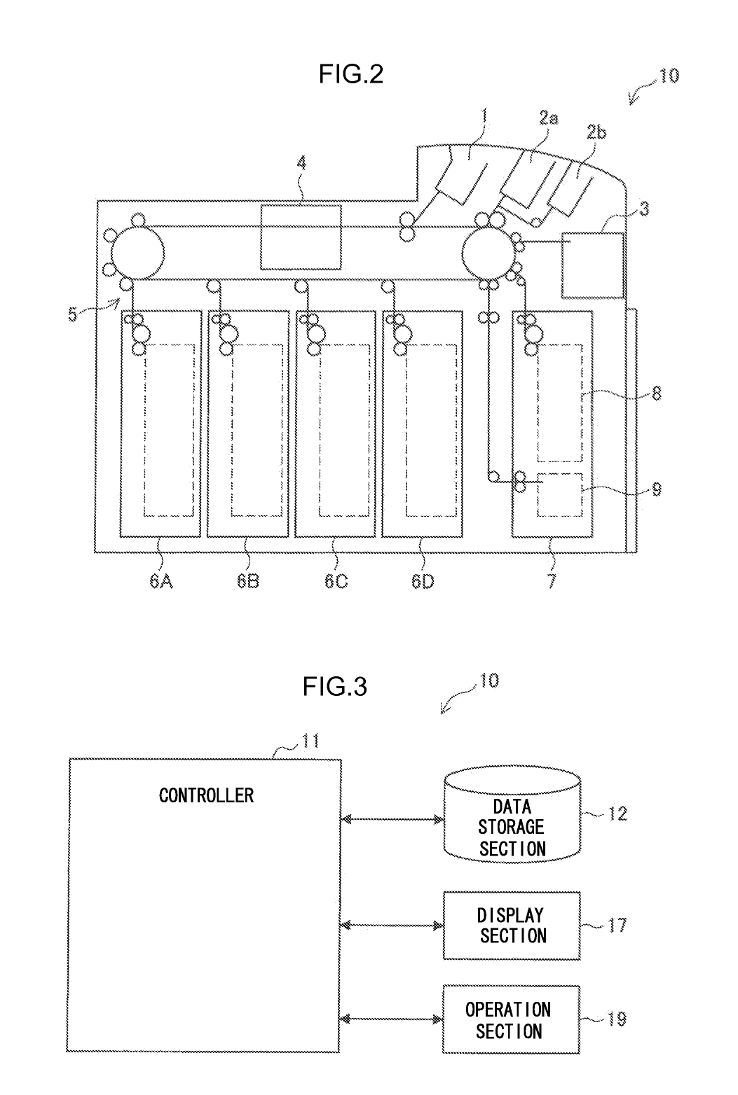

FIG. 2 illustrates an internal structure of the banknote processing device 10. As illustrated in FIG. 2, the banknote processing device 10 includes the input port 1, the output ports 2a, 2b, a temporary holding section 3, the banknote classification section 4, a conveyance section 5, banknote cassettes 6A to 6D, and a banknote cassette 7. The reject box-installed banknote cassette 7 includes a banknote storage box 8 and a reject box 9.

As described above, the input port 1 has a separating function for feeding out inserted banknotes, one note at a time. As described above, the output ports 2a, 2b have a stacking function for stacking dispensed banknotes. Note that the input port 1 and the output ports 2a, 2b may be movable, so as to be capable of inclining toward the conveyance path side or toward the side of an opening for collection by a cashier.

The temporary holding section 3 has both a banknote separating and a banknote stacking function. In a pay-in transaction, for example, the temporary holding section 3 temporarily stacks banknotes that have been separated out from the input port 1 and classified as normal by the banknote classification section 4. Banknotes stacked in the temporary holding section 3 are fed out on successful completion of a transaction, for example when the paid-in banknotes have been confirmed in the account, and are conveyed through the banknote classification section 4 to, for example, the banknote cassettes 6A to 6D. Note that the temporary holding section 3 may configured as a stacking type that sequentially stacks banknotes one on top of the other, or may configured as a drum type that stores banknotes by sequentially winding banknotes thereon.

The banknote classification section 4 classifies passing banknotes, one note at a time. Banknotes may travel in either direction, and the banknote classification section 4 is capable of classifying both banknotes being conveyed from the input port 1, and banknotes being conveyed from the opposite direction. Specifically, the banknote classification section 4 classifies a conveyed banknote passing through the conveyance path according to denomination, authenticity (genuine/counterfeit), physical condition (good/damaged condition note), and traveling state (normal/abnormal), conferring a normal determination or a reject determination on the passing banknote.

In the present specification, a genuine note means one that has been classified as a banknote, and a counterfeit note means one that has not been classified as a banknote. A good condition note means one of the banknotes classified as genuine notes and classified as suitable for pay-in/pay-out, and a damaged note means one of the banknotes classified as genuine notes and classified as not suitable for pay-in/pay-out. Reject determination is made based on factors such as counterfeit note, damaged note (for example, notes with dirt, damage, abnormal external profile), and traveling abnormality (for example skewed banknotes, overlapping travel). Reject banknotes may also include, for example, banknotes that cannot handled in pay-out, such as 2000 yen notes or 5000 yen notes, or foreign currency banknotes.

The conveyance section 5 includes respective conveyance paths that convey banknotes, respective conveyance rollers, and a drive mechanism for driving respective conveyance paths. The drive mechanism drives the conveyance paths by, for example, rotating a DC servomotor or a pulse motor. The conveyance section 5 is controlled by a controller (see the controller 11 in FIG. 3), described later, to convey a banknote to its conveyance destination.

The banknote cassettes 6A to 6D are banknote storage sections capable of storing banknotes according to denomination, and include both a banknote stacking function and separating function. The banknote cassettes 6A to 6D may include plural banknote cassettes for a single denomination. For example, the banknote cassettes 6A and 6C may be banknote cassettes for 10,000 yen notes, and the banknote cassettes 6B and 6D may be banknote cassettes for 1000 yen notes. The respective banknote cassettes 6A to 6D may be configured with a structure detachable from the banknote processing device 10, enabling individual replacement in order to load banknotes into the banknote cassettes 6A to 6D. Note that the banknote storage sections according to the present exemplary embodiment are not limited to cassettes that are detachable from the banknote processing device 10, and may be configured as stackers (banknote stackers A to D) that are non-detachable from the banknote processing device 10.

The reject box-installed banknote cassette 7 (also referred to below as banknote cassette 7) is equipped with the banknote storage box 8 at the upper side, and the reject box 9 at the lower side (bottom portion). The banknote cassette 7 has a structure detachable from the banknote processing device 10, enabling retrieval and replenishment of banknotes by individually replacing the banknote cassette 7.

The banknote storage box 8 has a stacking function for stacking banknotes and a separating function for feeding banknotes out, one note at a time. The banknote storage box 8 is capable of stacking banknotes that have been separated from each of the banknote cassettes 6A to 6D during counted cassette retrieval, and retrieving banknotes. In counted cassette replenishment, the banknote storage box 8 feeds out banknotes that have been stacked in the banknote storage box 8, to replenish banknotes in the banknote cassettes 6.

The reject box 9 only has a stacking function for stacking banknotes. The reject box 9 is a banknote storage section for stacking banknotes (reject banknotes) that the banknote classification section 4 has classified as abnormal (reject determination).

Detailed explanation has been given above regarding the internal structure of the banknote processing device 10 included in the banknote processing system according to the present exemplary embodiment. Explanation now follows regarding functional configuration of the banknote processing device 10 according to the present exemplary embodiment.

2-2. Functional Configuration

FIG. 3 is a block diagram illustrating a functional configuration of the banknote processing device 10 according to the present exemplary embodiment. As illustrated in FIG. 3, the banknote processing device 10 includes the controller 11, a data storage section 12, the display section 17, and the operation section 19. Explanation follows regarding these respective configuration elements, however, since the display section 17 and the operation section 19 have already been described above with reference to FIG. 1, further explanation thereof will be omitted.

The controller 11 controls overall operation of the banknote processing device 10. Specifically, the controller 11 controls basic operations such as pay-in, pay-out, retrieval, and check counting. Respective basic operations will be explained in detail in “2-3. Basic Operation”. The controller 11 moreover controls the overall banknote processing device 10 so as to perform basic operations as instructed by a cashier using the operation section 19 or basic operations as instructed by a cashier using the reception terminal 30.

During basic operations such as pay-in, pay-out, retrieval and check counting, the controller 11 according to the present exemplary embodiment also controls the conveyance section 5, thereby selecting the conveyance destination of banknotes among the plural output ports 2a, 2b, according to, for example, the number of banknotes and the denomination, and controlling conveying so as to dispense the selected banknotes at the selected output port. The controller 11 may also select the banknote conveyance destination from the plural output ports 2a, 2b according to the cause of reject determined by the banknote classification section 4.

The data storage section 12 holds, for example, classification results of the banknote classification section 4, and a balance of the banknote processing device 10 calculated from paid-in amounts and paid-out amounts.

Explanation of the functional configuration of the banknote processing device 10 according to the present exemplary embodiment has been given above. Note that the functions of the controller 11 and the data storage section 12 described above may be implemented by a hardware configuration including, for example, a Central Processing Unit (CPU), Read Only Memory (ROM), and Random Access Memory (RAM). The CPU includes computing functions and control functions, and controls overall operation of the banknote processing device 10 according to various programs. The ROM is stored with, for example, programs and computation parameters used by the CPU. The RAM is temporarily stored with, for example, a program used for execution by the CPU, and parameters that vary as appropriate during execution by the CPU.

2-3. Basic Operation

### Pay-in Transaction

In a pay-in transaction, banknotes from the input port 1 are first separated one note at a time, and the separated banknotes are conveyed to the banknote classification section 4. Banknotes given a classification result of normal by the banknote classification section 4 are then passed out from the banknote classification section 4 and are stacked in the temporary holding section 3. Then, once the pay-in amount has been approved, processing transitions to stacking processing.

However, any banknotes (reject banknotes) given a classification result of abnormal by the banknote classification section 4 are stacked in the output port 2a or the output port 2b. It is possible to re-classify the banknotes stacked in the output ports 2a, 2b by a cashier re-inserting the banknotes into the input port 1. Note that a detailed explanation regarding conveyance control of banknotes during pay-in transactions according to the present exemplary embodiment is given later under “3-5. Fifth Exemplary Embodiment”

In the stacking processing, banknotes from the temporary holding section 3 are first separated one note at a time, and the separated banknotes are conveyed to the banknote classification section 4. Banknotes given a classification result of normal by the banknote classification section 4 are stacked in the banknote cassette 6A to 6D of the corresponding denomination. However, any banknotes (reject banknotes) given a classification result of abnormal by the banknote classification section 4, such as dirty or folded 10,000 yen notes or 1000 yen notes, 2000 yen notes, 5000 yen notes, or banknotes traveling abnormally such as skewed banknotes, are stacked in the reject box 9.

Transition is made to return processing when return of pay-in banknote (cancellation) is instructed prior to approval of a pay-in amount. In the return processing, banknotes from the temporary holding section 3 are first separated one note at a time, and the separated banknotes are conveyed to the banknote classification section 4. All of the banknotes are stacked in the output ports 2a, 2b regardless of whether the banknote classification section 4 gives a classification result of normal or abnormal.

Direct Pay-in

Note that as a pay-in transaction operation, direct pay-in processing is possible, in which pay-in banknotes are stacked directly in the banknote cassettes 6A to 6D without being held back in the temporary holding section 3, in addition to the normal pay-in processing described above, in which the pay-in banknotes are temporarily held in the temporary holding section 3 before being stacked in the banknote cassettes 6A to 6D from the temporary holding section 3.

In the direct pay-in processing, banknotes from the input port 1 are firstly separated one note at a time, and the separated banknotes are conveyed to the banknote classification section 4. Banknotes given a classification result of normal by the banknote classification section 4 are stacked in the banknote cassette 6A to 6D of the corresponding denomination. However, banknotes (reject banknotes) given a classification result of abnormal by the banknote classification section 4 are stacked in the output port 2a or in the output port 2b. The cashier may reinsert any banknotes stacked in the output port 2a, or in the output port 2b, into the input port 1 for reclassification.

The direct pay-in processing thereby enables pay-in processing time to be shortened compared to the normal pay-in processing described above, since banknotes are stacked directly in the banknote cassettes 6 without being temporarily held in the temporary holding section 3. Moreover, the direct pay-in processing enables a reduction in travel, and therefore a reduction in the occurrence of jams, since there is no need to temporarily hold the banknotes in the temporary holding section 3. The direct pay-in processing accordingly enables pay-in transactions, for example, when the temporary holding section 3 cannot be utilized, due to malfunction of the like, as well as in structures that do not include the temporary holding section 3. In the banknote processing device 10 according to the present exemplary embodiment, a setting may be made to select between the normal pay-in processing, described above, and the direct pay-in processing.

Pay-Out Transaction

In a pay-out transaction, banknotes corresponding to a specified amount are first separated from the banknote cassettes 6A to 6D, one note at a time, and the separated banknotes are conveyed to the banknote classification section 4.

Then, banknotes given a classification result of normal by the banknote classification section 4 are stacked in the output port 2a or in the output port 2b. Specifically, payout is made selectively from the output ports 2a, 2b according to, for example, the denomination or number of notes of normal banknotes for paying out. However, banknotes given a classification result of abnormal by the banknote classification section 4, namely banknotes that cannot be paid out to a customer, are stacked in the reject box 9.

Replenishment Operation

Replenishment operation is a basic operation for replenishing banknotes in the banknote processing device 10. In the banknote processing device 10 according to the present exemplary embodiment, specific possible replenishment methods include insertion port replenishment, cassette replacement replenishment, and counted cassette replenishment. Explanation follows in sequence regarding each of these replenishment methods.

Insertion Port Replenishment

Insertion port replenishment has operation similar to the pay-in transaction and the stacking processing described above. For example, banknotes stacked in the input port 1 (insertion port) are separated into individual notes, and the separated notes are conveyed to the banknote classification section 4. Banknotes given a classification result of normal by the banknote classification section 4 are temporarily held in the temporary holding section 3, and then stacked in the banknote cassette 6A to 6D of the corresponding denomination. However, banknotes given a classification result of abnormal by the banknote classification section 4 are stacked in the output port 2a, or the output port 2b.

Cassette Replacement Replenishment

Cassette replacement replenishment makes use of the detachability of the banknote cassettes 6A to 6D. Banknotes are replenished by replacing any of the banknote cassettes 6A to 6D with a banknote cassette that has been preloaded with banknotes. Note that in the cassette replacement replenishment, an operator must manually record the denomination and number of replenished banknotes.

Counted Cassette Replenishment

In counted cassette replenishment, the banknote storage box 8 of the banknote cassette 7 is preloaded with banknotes and set in the banknote processing device 10. Banknotes are fed out from the banknote storage box 8, one note at a time, and the fed out banknotes are conveyed to the banknote classification section 4. Banknotes given a classification result of normal by the banknote classification section 4 are stacked in the banknote cassette 6A to 6D of the corresponding denomination. However, banknotes given a classification result of abnormal by the banknote classification section 4 are stacked in the reject box 9. Since counting processing is executed by the banknote classification section 4 in the counted cassette replenishment, there is no need for the denomination and number of replenished banknotes to be manually recorded by an operator.

Retrieval Operation

Retrieval operation is a basic operation to retrieve banknotes from the banknote processing device 10. In the banknote processing device 10 according to the present exemplary embodiment, specific possible retrieval methods are output port retrieval, cassette replacement retrieval, and counted cassette retrieval. Explanation follows, in sequence, regarding each of the retrieval methods.

Output Port Retrieval

Output port retrieval is similar to operation described above for pay-out transactions. First, banknotes are separated, one note at a time, from the retrieval target banknote cassette 6, and the separated banknotes are conveyed to the banknote classification section 4. Then, banknotes that have been given a classification result of normal by the banknote classification section 4 are stacked in the output ports 2a, 2b. However, banknotes that have been given a classification result of abnormal by the banknote classification section 4 are stacked in the reject box 9. Such processing is performed for all the banknotes stacked in the banknote cassette 6 subject to retrieval, and an operator may retrieve normal-determination banknotes from the output ports 2a, 2b. Banknotes determined to be abnormal may be retrieved from the reject box 9.

Cassette Replacement Retrieval

Cassette replacement retrieval makes use of the detachability of the banknote cassettes 6A to 6D. A retrieval operation is performed by removing from the banknote processing device 10 a specific banknote cassette 6 in which banknotes have been stacked. Note that in the cassette replacement retrieval, an operator has to take the banknotes out from the removed banknote cassette 6 and manually count the denomination and number of the retrieved banknotes.

Counted Cassette Retrieval

In counted cassette retrieval, banknotes are firstly fed out, one note at a time from a retrieval target banknote cassette out of the banknote cassettes 6A to 6D, and the fed out banknotes are conveyed to the banknote classification section 4. Banknotes given a classification result of normal by the banknote classification section 4 are stacked in the banknote storage box 8 of the banknote cassette 7. However, banknotes given a classification result of abnormal by the banknote classification section 4 are stacked in the reject box 9.

After this processing has been performed for all of the banknotes stacked in the retrieval target banknote cassette 6, an operator may retrieve the normal-determination banknotes and the abnormal determination banknotes by removing only the banknote cassette 7 from the banknote processing device 10. Since counting processing is executed by the banknote classification section 4 in the counted cassette retrieval, there is no need for the operator to manually count the denomination and number of retrieved banknotes.

2-4. Check Counting Operation

As basic operations, each of the banknote processing devices 10 according to the present exemplary embodiment performs a check counting operation, in addition to the pay-in/pay-out transactions, and the replenishment and retrieval operations described above. Specifically, the check counting operation includes a mode that sorts banknotes for counting by denomination and number of notes, and a mode that sorts banknotes into genuine or counterfeit notes.

In the check counting operation, banknotes from the input port 1 are first separated one note at a time, and the separated banknotes are conveyed to the banknote classification section 4, where classification and counting processing of the banknotes is executed by the banknote classification section 4. Then, banknotes are selectively stacked in the output port 2a or in the output port 2b according to the classification result by the banknote classification section 4. Note that a detailed explanation regarding conveyance control of banknotes during check counting operation according to the present exemplary embodiment follows under “3. Exemplary Embodiments”.

### 3. EXEMPLARY EMBODIMENTS

Explanation next follows regarding control of selection of the conveyance destination of banknotes from the plural output ports 2a, 2b, and regarding control of banknote conveyance to the selected output port in the present exemplary embodiments, with examples given for plural exemplary embodiments. In the present exemplary embodiments, as explained below, the convenience of the banknote processing device 10 can be improved by selectively dispensing banknotes from the plural output ports 2a, 2b.

### 3-1. First Exemplary Embodiment

In the first exemplary embodiment, in pay-out transactions, output port retrieval, or check counting operations, banknotes of the same denomination are stacked in the plural output ports 2a, 2b at respective specific numbers of notes. As described above, each of the output ports 2a, 2b according to the present exemplary embodiment has a stacking capacity capable of respectively stacking stacks of 100 banknotes. Therefore, for example, the controller 11 may first select one output port of the output ports 2a, 2b and convey 100 banknotes to the selected port, and then may select the other port and convey 100 banknotes to the other output port.

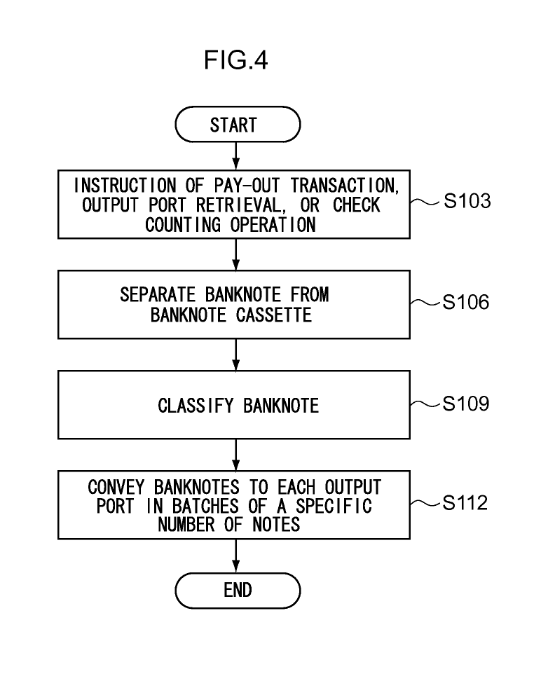

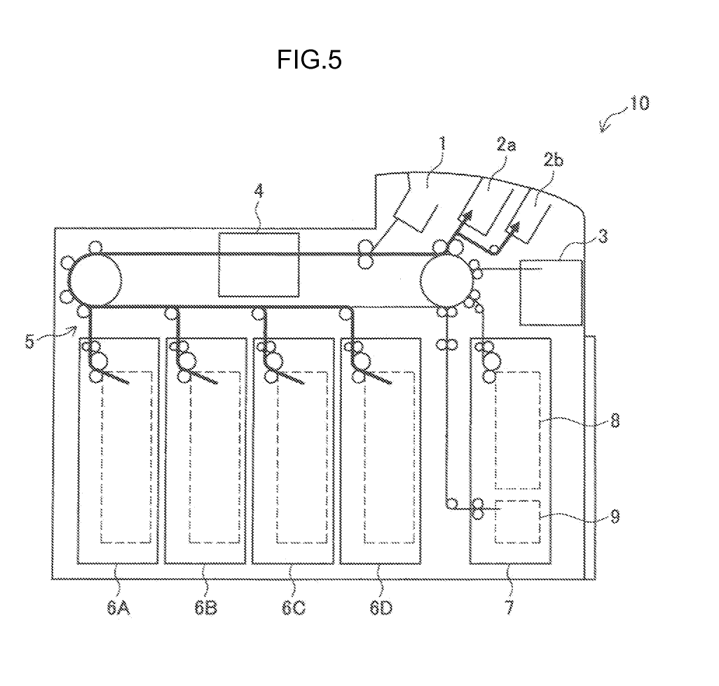

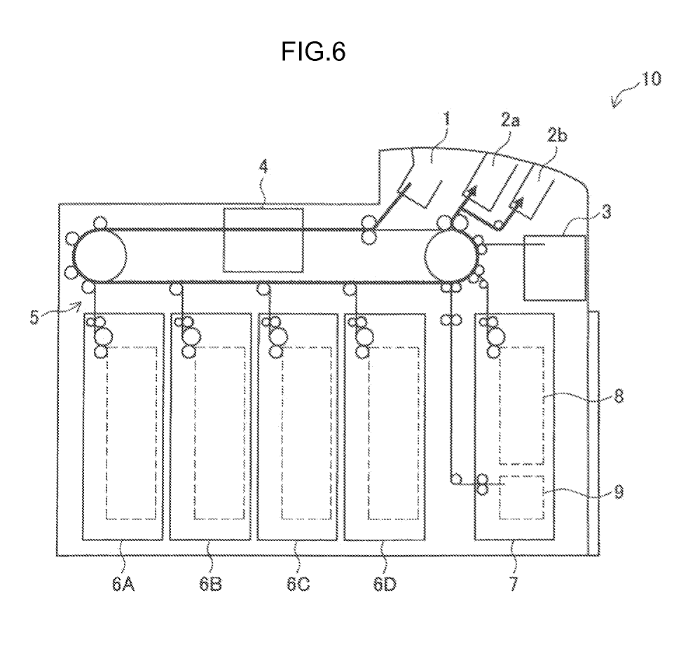

Explanation next follows regarding the present exemplary embodiment, with reference to FIG. 4 to FIG. 6. FIG. 4 is a flow chart illustrating processing for dispensing banknotes by number of notes according to a first exemplary embodiment. FIG. 5 is a diagram illustrating banknote conveying paths in pay-in/pay-out retrieval according to the first exemplary embodiment. FIG. 6 is a diagram illustrating banknote conveying paths in the check counting operation according to the first exemplary embodiment.

As illustrated in FIG. 4, first, at step S103, a pay-out transaction, output port retrieval, or a check counting operation is instructed by the cashier. Explanation follows regarding a case in which, for example, a pay-out transaction of 440 notes of 1000 yen is instructed.

Next, at step S106, the controller 11 effects conveyance control of separating banknotes, one note at a time, from a specific banknote cassette 6 according to the instructed denomination and number of notes, and delivering the separated banknotes to the banknote classification section 4. For example, the controller 11 feeds out (separates) banknotes one note at a time from the 1000 yen banknote cassettes 6B and 6D, and delivers the banknotes to the banknote classification section 4.

Next, at step S109, the banknote classification section 4 classifies the respective conveyed banknotes, such as by denomination and banknote condition. Banknotes classified by the banknote classification section 4 as abnormal (reject determination) are stacked in the reject box 9.

At step S112, banknotes that are classified by the banknote classification section 4 as normal are conveyed to the output ports 2a, 2b in batches of a specific number of notes. For example, in a case as described above in which an instruction for a payout of 440 notes of 1000 yen is received, the controller 11 first stacks a stack of 100 notes of 1000 yen banknotes in the output port 2a, and then proceeds to stack a stack of 100 notes of 1000 yen banknotes in the output port 2b. The cashier sequentially collects and binds the 100 notes of 1000 yen banknotes that have been stacked respectively in the output ports 2a, 2b.

After the cashier has collected the 100 notes of 1000 yen banknotes stacked in the output port 2a, the controller 11 then stacks 100 notes of 1000 yen banknotes that have not been paid out in the output port 2a. Similarly, after the cashier has collected the 100 notes of 1000 yen banknotes stacked in the output port 2b, the controller 11 then stacks 100 notes of 1000 yen banknotes that have not been paid out in the output port 2b. The cashier sequentially collects and binds the 100 notes of 1000 yen banknotes stacked in the output ports 2a, 2b.

Then, after the cashier has collected the 100 notes of 1000 yen banknotes stacked in the output port 2a, the controller 11 then stacks 40 notes of 1000 yen banknotes that have not been paid out in the output port 2a. The cashier then passes to the customer the pay-out banknotes of the four bound bundles (400 notes) and the balance of 40 notes.

As explained in the above specific example, the controller 11 sequentially dispenses 440 notes of 1000 yen banknotes in batches of 100 notes each to the output ports 2a, 2b, followed by the final balance of 40 notes. Thus, since banknotes are paid out in batches of 100 notes, which is a number of notes that facilitates counting by the cashier and that is easily bound, the operation of the cashier may be smooth, and the convenience in pay-out transactions is improved. Further, while the cashier is collecting 100 notes stacked in the output port 2a, a further 100 notes are being paid out at the output port 2b, enabling a large amount of pay out operations to be accomplished in a short period of time.

Note that the conveying paths of the pay-out banknotes in such a pay-out transaction are illustrated by the arrows in FIG. 5. As illustrated by the arrows in FIG. 5, a specific number of notes of a specific denomination according to the payout instruction are separated from the banknote cassettes 6A to 6D, and conveyed one note at a time, to the banknote classification section 4. Then banknotes classified as normal by the banknote classification section 4 are paid out to the output ports 2a, 2b in batches of a specific number of notes. Note that banknotes classified as abnormal by the banknote classification section 4 are stacked in the reject box 9.

The above specific example is of a pay-out transaction; however, in the present exemplary embodiment, similar improvements in convenience are attainable in transactions other than pay-out transactions, as shown by step S103, such as output port retrieval, or check counting operations, by dispensing a specific number of notes from plural output ports.

Note that the conveying paths for the output port retrieval are similar to the conveying paths of pay-out banknotes in pay-out transactions as described above with reference to FIG. 5. The controller 11 separates banknotes, one note at a time, from a specific banknote cassette 6 of the banknote cassettes 6A to 6D according to the retrieval instruction, and delivers the separated banknotes to the banknote classification section 4. The controller 11 then stacks banknotes classified as normal by the banknote classification section 4 in the output ports 2a, 2b, for example as batches of 100 notes. Note that any banknotes classified as abnormal by the banknote classification section 4 are stacked in the reject box 9.

The conveying path of the banknote during the check counting operation is as illustrated by the arrows in FIG. 6. As illustrated by the arrows in FIG. 6, the banknotes are separated one note at a time from the input port 1, and the separated banknotes are conveyed to the banknote classification section 4. Then, notes that have been classified as normal by the banknote classification section 4 are paid out to the output ports 2a, 2b in batches of a specific number of notes. Note that configuration may be made such that any banknotes classified as abnormal by the banknote classification section 4 are temporarily held in the temporary holding section 3, and then are dispensed to the output port 2a or 2b, after all the banknote stacked in the input port 1 have been separated.

### 3-2. Second Exemplary Embodiment

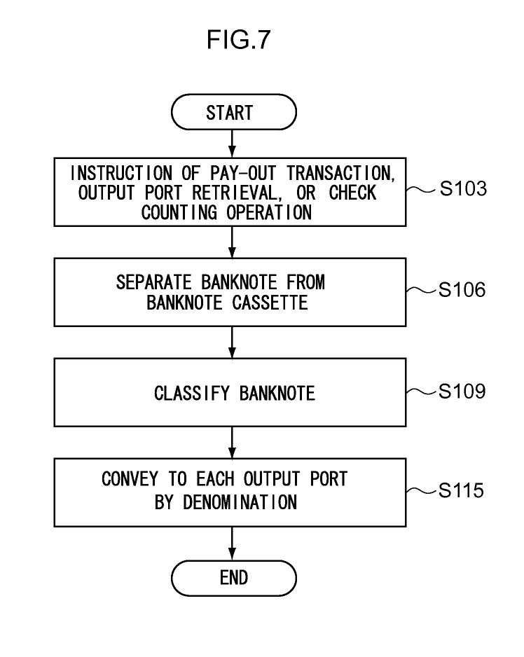

In the second exemplary embodiment, in pay-out transactions, output port retrieval, or check counting operations, banknotes are stacked in the plural output ports 2a, 2b according to the denomination of the banknotes. Dispensing the banknotes to the plural output ports 2a, 2b by denomination facilitates the cashier discriminating the denominations, and raises the convenience of the banknote processing device 10. Explanation follows regarding the present exemplary embodiment, with reference to FIG. 7. FIG. 7 is a flow chart illustrating processing for dispensing banknotes by denomination according to the second exemplary embodiment.

Steps S103 to S109 in FIG. 7 are similar to the processing of the same steps as explained with reference to FIG. 4. Note that in the present exemplary embodiment, at step S103, a payout instruction is given to payout, for example, 40 notes of 1000 yen notes, and 50 notes of 5000 yen notes.

Next, at step S115, the banknotes classified as normal by the banknote classification section 4 are conveyed by denomination to the output ports 2a, 2b. For example, on receipt of a payout instruction as described above to payout 40 notes of 1000 yen banknotes, and 50 notes of 5000 yen banknotes, the controller 11 first selects the output port 2a as the conveyance destination, and stacks 40 notes of 1000 yen banknotes in the selected output port 2a. The controller 11 then selects output port 2b as the conveyance destination, and stacks 50 notes of 5000 yen banknotes in the selected output port 2b. The cashier then places together the banknotes collected from the output ports 2a, 2b according to denomination, and passes these banknotes to the customer.

Note that the banknotes classified as abnormal (reject determination) by the banknote classification section 4 are stacked in the reject box 9.

As explained in the specific example given above, the controller 11 pays out the 1000 yen banknotes and the 5000 yen banknotes separately to the respective output ports 2a, 2b. Since the second exemplary embodiment pays out the banknote separately according to denomination so as to facilitate discrimination by the cashier of the denomination of the banknotes, the operation of the cashier may be smooth, and the convenience in pay-out transactions is improved.

Moreover, a specific example of a pay-out transaction has been explained above; however, in the present exemplary embodiment, similar improvements in convenience are attainable in transactions other than pay-out transactions, as shown by step S103 in FIG. 7, such as output port retrieval, or check counting operations, by dispensing banknotes separately according to denomination from plural output ports.

Although a specific example has been explained in which two types of banknotes are paid out from two output ports, embodiments are not limited thereto, and, for example, three types of banknote can be paid out separately by denomination from two output ports. Specifically, the controller 11 first respectively pays out banknotes with denominations of a first type and a second type at the output ports 2a, 2b. The controller 11 then pays out banknotes of the third type at an output port that becomes vacant as banknotes are collected by the cashier.

### Modified Example

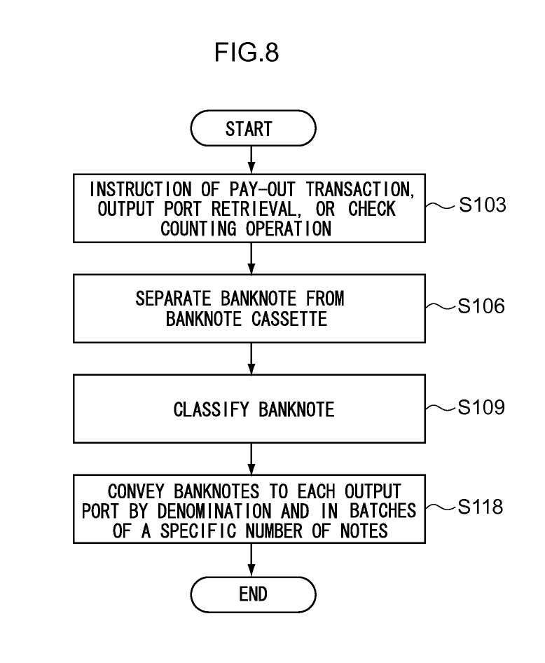

Explanation next follows, as a modified example of the second exemplary embodiment, regarding banknote conveyance control to select the conveyance destination from plural output ports 2a, 2b by denomination and for each specific number of notes, and to convey banknotes to the selected output port. Dispensing banknotes to the plural output ports 2a, 2b by denomination and for each specific number of notes makes facilitates the cashier to discriminate the denomination and number of notes, and improves the convenience of the banknote processing device 10. Explanation follows regarding the modified example of the second exemplary embodiment, with reference to FIG. 8. FIG. 8 is a flow chart illustrating processing for dispensing banknotes by denomination and in batches of a specific number of notes, according to the modified example of the second exemplary embodiment.

Steps S103 to S109, illustrated in FIG. 8, are similar to the processing of the same steps explained with reference to FIG. 4. Note that in the present modified example, at step S103 a pay-out transaction is instructed for, for example, a payout of 150 notes of 1000 yen banknotes, and 150 notes of 5000 yen banknotes. The output ports 2a, 2b of the present modified example have, for example, respective stacking capacities for 100 notes.

Then at step S115, banknotes classified as normal by the banknote classification section 4 are conveyed to the output ports 2a, 2b, by denomination and in batches of a specific number of notes. For example, on receipt of a payout instruction such as the above to dispense 150 notes of 1000 yen banknotes, and 150 notes of 5000 yen banknotes, the controller 11 first selects the output port 2a as the conveyance destination, and stacks 100 notes of 1000 yen banknotes in the selected output port 2a. The controller 11 then selects the output port 2b as the conveyance destination, and stacks 100 notes of 5000 yen banknotes in the selected output port 2b. The cashier sequentially collects 100 notes of each type of banknote stacked in the output ports 2a, 2b, and binds each of them.

Then, after the cashier has collected the 100 notes of 1000 yen banknotes stacked in the output port 2a, the controller 11 stacks the 50 notes of 1000 yen banknotes that have not been paid out in the output port 2a. Similarly, after the cashier has collected the 100 notes of 5000 yen banknotes stacked in the output port 2b, controller 11 stacks the 50 notes of 5000 yen banknotes that have not been paid out in the output port 2b. Then, the cashier places the final 50 notes of 1000 yen banknotes and 50 notes of 5000 yen banknotes, by denomination, on the two bound bundles (the 100 notes of 1000 yen banknotes, and the 100 notes of 5000 yen banknotes) and passes them to the customer.

As explained above, in the present modified example, since the banknotes are paid out from the plural output ports by denomination and in batches of a specific number of notes, discrimination of the denomination and number of notes by the cashier is facilitated, the operation of the cashier may be smooth, and the convenience in pay-out transactions is improved.

Moreover, although an example has been explained above of a pay-out transaction, similar improvements in convenience are attainable in transactions other than pay-out transactions in the present modified example, as shown by step S103 of FIG. 8, such as output port retrieval, or check counting operations, by dispensing banknotes by denomination and in batches of a specific number of notes from the plural output ports.

### 3-3. Third Exemplary Embodiment

In a third exemplary embodiment, in a physical condition sort mode of check counting operation, the conveyance destination is selected from the output ports 2a, 2b, depending on whether a banknote is a good condition note or a damaged note, and the banknote is then conveyed to the selected output port. This thereby enables a cashier to sort banknotes into good condition notes and damaged notes, improving the convenience of the banknote processing device 10.

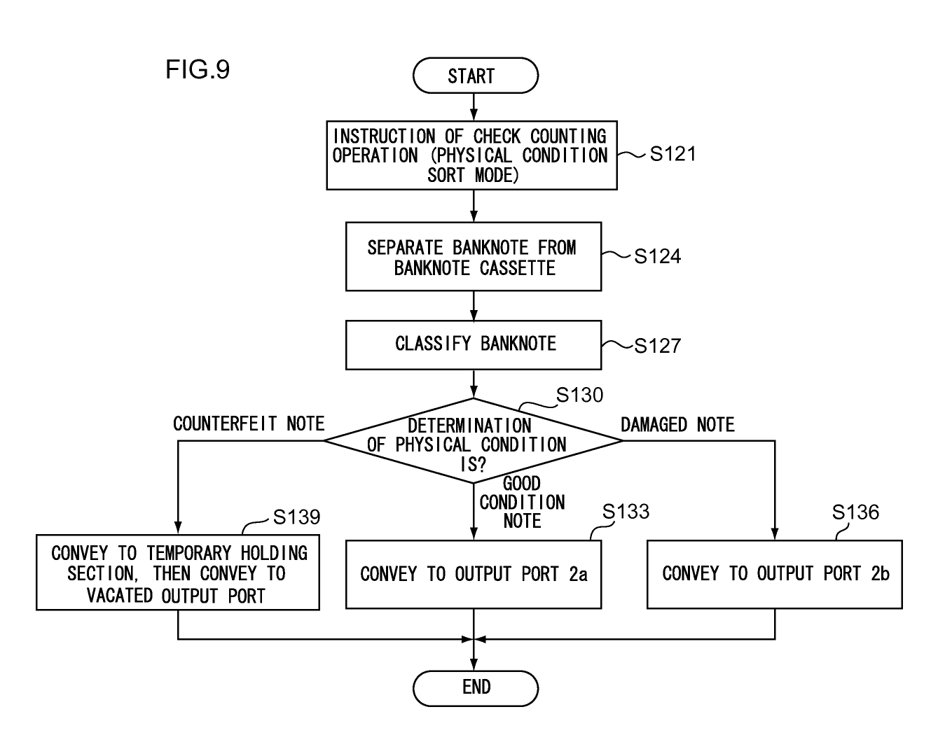

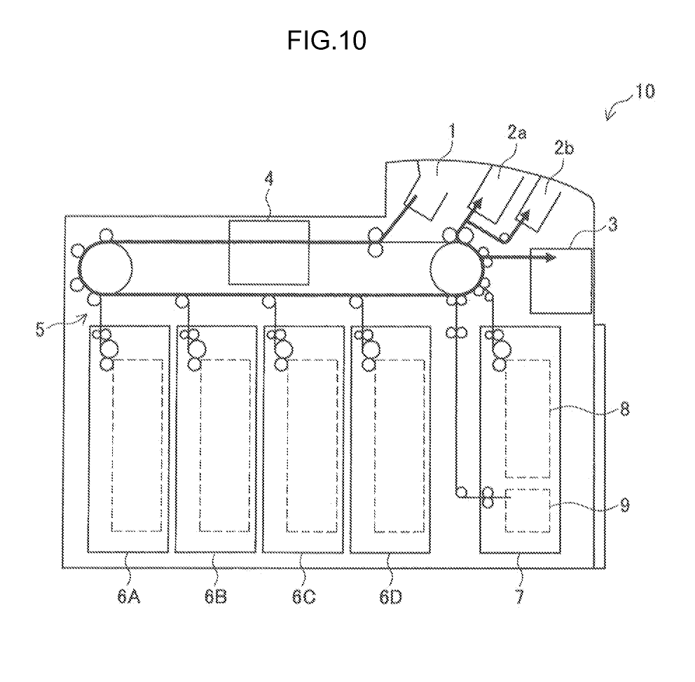

Explanation next follows regarding the present exemplary embodiment, with reference to FIG. 9 and FIG. 10. FIG. 9 is a flow chart illustrating processing in the third exemplary embodiment to convey banknotes according to their physical condition. FIG. 10 is a diagram illustrating a conveyance path during conveying banknotes according to their physical condition, according to the third exemplary embodiment.

As illustrated in FIG. 9, first, at step S121, after the physical condition sort mode of check counting operation has been instructed by the cashier, then, at step S124, the controller 11 separates banknotes from a bundle of banknote stacked in the input port 1, one note at a time, and controls conveying to deliver the separated notes to the banknote classification section 4.

Then, at step S127, the banknote classification section 4 classifies (differentiates) the conveyed banknotes, and performs physical condition determination.

Then, the banknotes determined to be good condition notes at step S130 by the banknote classification section 4 are conveyed to the output port 2a at step S133.

However, the banknotes determined at step S130 to be damaged notes by the banknote classification section 4 are conveyed to the output port 2b at step S136.

Note that in the present exemplary embodiment, in a case in which a counterfeit note has been detected by the banknote classification section 4 at step S130, the counterfeit note may be temporarily held in the temporary holding section 3 at step S139. The counterfeit note temporarily held in the temporary holding section 3 is then conveyed to a vacated output port from which banknotes have been collected, out of the plural output ports 2a, 2b.

As explained above, in the third exemplary embodiment, since the banknotes stacked in the input port 1 are sorted and dispensed to the respective plural output ports 2a, 2b according to the physical condition of the banknotes (quality of the banknotes), the cashier may sort the banknotes into good condition notes and damaged notes, and the convenience of the banknote processing device 10 is improved. Moreover, in the present exemplary embodiment, in a case in which a counterfeit note has been detected, by dispensing the counterfeit note separately to the good condition notes and damaged notes, the convenience can be further improved.

Note that the conveyance path of the banknotes in the above physical condition sort mode of check counting operation is as indicated by the arrows in FIG. 10. As indicated by the arrows in FIG. 10, the banknotes separated from the input port 1 are conveyed, one note at a time, to the banknote classification section 4, and then conveyed to the output port 2a or the output port 2b according to the good/damaged determination by the banknote classification section 4. Any banknote determined to be a counterfeit note by the banknote classification section 4 is conveyed to the temporary holding section 3, and then, after the banknotes have been collected from the output ports 2a, 2b, conveyed to the empty output port.

The third exemplary embodiment may be combined with the first exemplary embodiment, so as to dispense banknotes from the plural output ports 2a, 2b separately by physical condition of the banknotes and in batches of a specific number of notes. More specifically, for example, the good condition notes may be dispensed in batches of 100 notes at the output port 2a, and the damaged notes may be dispensed in batches of the 100 notes at the output port 2b. This facilitates the cashier to discriminate the banknotes into the good condition notes and damaged notes, thereby further improving the convenience in the physical condition sort mode of the check counting operation.

### 3-4. Fourth Exemplary Embodiment

In the fourth exemplary embodiment, in an authenticity sort mode of check counting operation, the conveyance destination is selected from the output ports 2a, 2b according to whether a banknote is a genuine or counterfeit note, and the banknote is then conveyed to the selected output port. This thereby enables the cashier to sort the banknotes into genuine or counterfeit notes, improving the convenience of the banknote processing device 10.

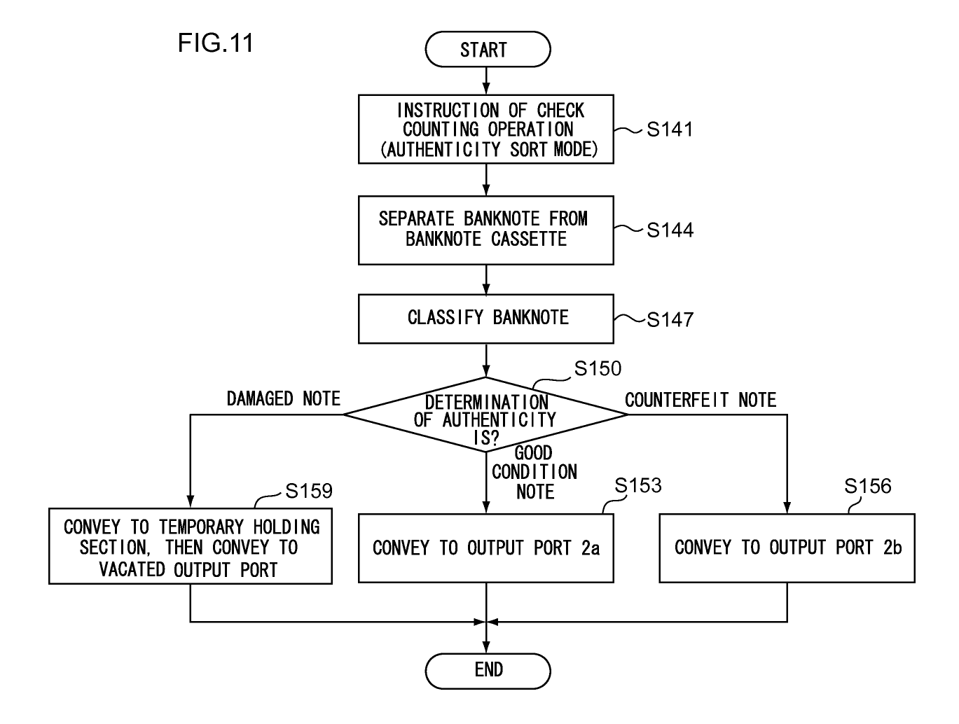

Explanation follows regarding the present exemplary embodiment, with reference to FIG. 11. FIG. 11 is a flow chart illustrating conveyance processing of banknotes according to authenticity, according to the fourth exemplary embodiment.

As illustrated in FIG. 11, first, after the authenticity sort mode of check counting operation is instructed by the cashier at step S141, next at step S144, the controller 11 effects control of separating banknotes, one note at a time, from a bundle stacked in the input port 1, and conveying the stacked banknotes to the banknote classification section 4.

Then, at step S147, the banknote classification section 4 classifies (differentiates) the conveyed banknotes, and performs authenticity determination.

Next, out of the banknotes classified by the banknote classification section 4 at step S150 as genuine notes, good condition notes classified as being suitable for payout are conveyed to the output port 2a at step S153.

However, banknotes determined by the banknote classification section 4 at step S150 to be counterfeit notes are conveyed to the output port 2b at step S156.

Note that in the present exemplary embodiment, out of the banknotes classified as genuine notes at step S150, any damaged notes determined not suitable for payout by the banknote classification section 4 may be temporarily held in the temporary holding section 3 at step 159. The damaged notes temporarily held in the temporary holding section 3 are then conveyed to a vacated output port from which banknotes have been collected, out of the plural output ports 2a, 2b.

As explained above, in the fourth exemplary embodiment, the banknotes stacked in the input port 1 are dispensed at the plural output ports 2a, 2b sorted according to authenticity of the banknotes, thereby facilitating the cashier to sort banknotes into genuine or counterfeit notes, and improving the convenience of the banknote processing device 10. The present exemplary embodiment further enables the convenience in the check counting operation to be further improved, by sorting the genuine notes into good condition and damaged notes, and separately dispensing the good condition notes, the damaged notes, and the counterfeit notes.

Note that the fourth exemplary embodiment may be combined with the first exemplary embodiment, so as to dispense banknotes from the plural output ports 2a, 2b with the banknotes separated into genuine notes and counterfeit notes, and also in batches of a specific number of notes. More specifically, for example, genuine notes may be dispensed in batches of 100 notes at the output port 2a, and the counterfeit notes may be dispensed in batches of 100 notes at the output port 2b. This thereby facilitates the cashier to discriminate the authenticity and number of notes of the banknotes, and improves the convenience in the authenticity sort mode of the check counting operation.

### 3.5 Fifth Exemplary Embodiment

In a fifth exemplary embodiment, the conveyance destination of rejected banknotes in a pay-in transaction is selected out of the output ports 2a, 2b according to cause of rejection, more specifically, according to whether or not the banknote is a counterfeit note or other reject note, and the banknotes are then conveyed to the selected conveyance destination.

Normally, in a pay-in transaction, banknotes classified as normal by the banknote classification section 4 are temporarily held in the temporary holding section 3, and then, after transitioning to stacking processing, are stacked in the banknote cassettes 6A to 6D according to denomination. However, banknotes classified as abnormal by the banknote classification section 4 (reject determination) are dispensed from the output port, and may be re-classified due to the cashier re-inserting the banknotes to the input port 1. Reject determination is made based on factors such as counterfeit notes, damaged notes (for example, notes with dirt, damage, abnormal external profile), and traveling abnormality (for example, skewed banknotes, overlapping travel). Hence, although there are banknotes worth re-classifying, there are also banknotes, such as counterfeit notes, for which there is no point in re-classifying. Thus, in the fifth exemplary embodiment, reject notes are dispensed respectively from the output ports 2a, 2b, while sorted into counterfeit notes and other reject notes. The cashier is accordingly able to save wasted effort in re-inserting any counterfeit notes, thereby exhibiting the advantageous effect of saving operation time.

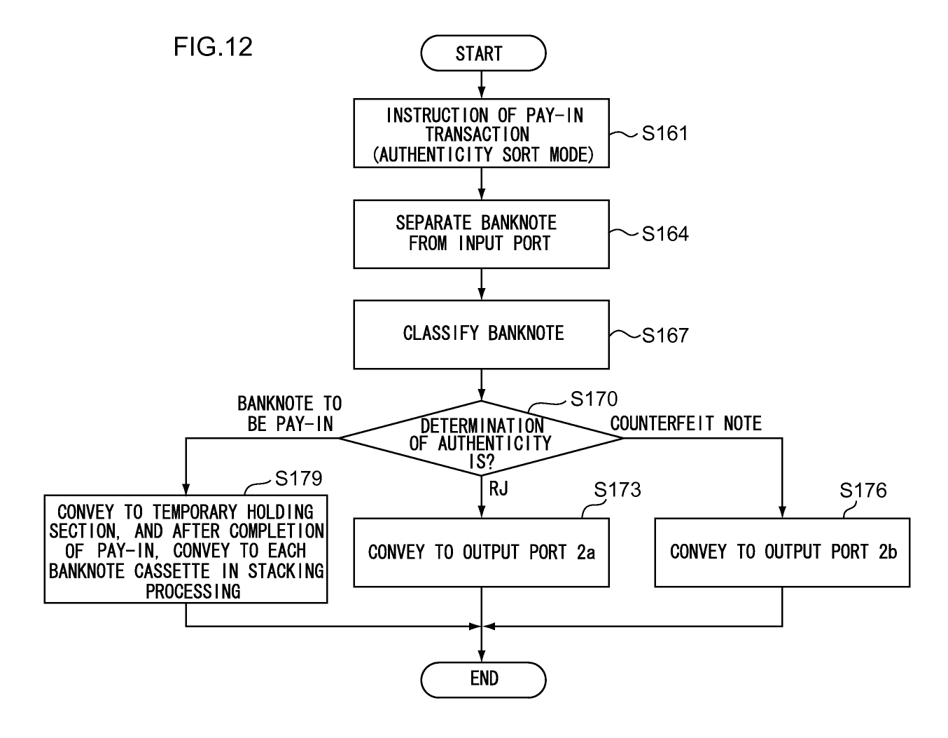

Explanation follows regarding the present exemplary embodiment, with reference to FIG. 12. FIG. 12 is a flow chart illustrating processing according to the fifth exemplary embodiment to convey banknotes according to authenticity.

As illustrated in FIG. 12, first the authenticity sort mode of a pay-in transaction is instructed by the cashier at step S161. Then at step S164, the controller 11 effects control of separating the banknotes, one note at a time, from a bundle of banknotes stacked in the input port 1, and conveying the separated banknotes to deliver them to the banknote classification section 4.

Then, at step S167, the banknote classification section 4 classifies (differentiates) the conveyed banknotes, and performs authenticity determination.

Then, at step S170, out of the banknotes classified by the banknote classification section 4 as genuine notes, banknotes to be paid in are temporarily held in the temporary holding section 3 at step 179, and after completing pay-in (after the pay-in amount has been approved), the banknotes are stacked in the banknote cassettes 6A to 6D according to the denomination in stacking processing.

Any banknotes determined at step S170 to be counterfeit notes by the banknote classification section 4 are conveyed to the output port 2b at step S176.

Any banknotes, out of the banknotes classified as genuine notes by the banknote classification section 4 at step S170, that are not suitable for pay-in (other rejected banknotes, such as damaged notes) are conveyed to the output port 2a at step S173. Then, the cashier performs re-classification by re-inserting the rejected banknotes dispensed from the output port 2a into the input port 1.

As explained above, in the fifth exemplary embodiment, the banknotes rejected during a pay-in transaction are sorted according to cause of rejection, namely into counterfeit notes and other rejected banknotes (such as damaged notes), and respectively dispensed from the output ports 2a, 2b. This thereby facilitates the cashier to discriminate between counterfeit and genuine notes, and, by only re-classifying rejected banknotes other than the counterfeit note, enables the operation time and the processing time required for pay-in transactions to be effectively shortened.

### 3-5. Sixth Exemplary Embodiment

In a sixth exemplary embodiment, in a check counting operation, the conveyance destination is selected from the output ports 2a, 2b according to the reject (RJ) cause, and the banknotes are conveyed to the selected output port.

As described above, the reject determination is based on various factors such as counterfeit notes, damaged notes (for example, notes with dirt, damage, abnormal external profile), and traveling abnormality (for example, skewed banknotes, overlapping travel). However, the third and the fourth exemplary embodiments are modes in which banknotes are sorted into three types: good condition notes, damaged notes, and counterfeit notes.

In the sixth exemplary embodiment, as a RJ cause sort mode of check counting operation, the rejected banknotes are respectively dispensed from the output ports 2a, 2b according to the RJ cause, enabling the cashier to sort banknotes according to RJ cause. In this way, the present exemplary embodiment enables, for example, further sorting of damaged notes into dirty notes, damaged notes, and notes with abnormal external profile, and enables abnormal travelling notes to be extracted from the rejected banknotes.

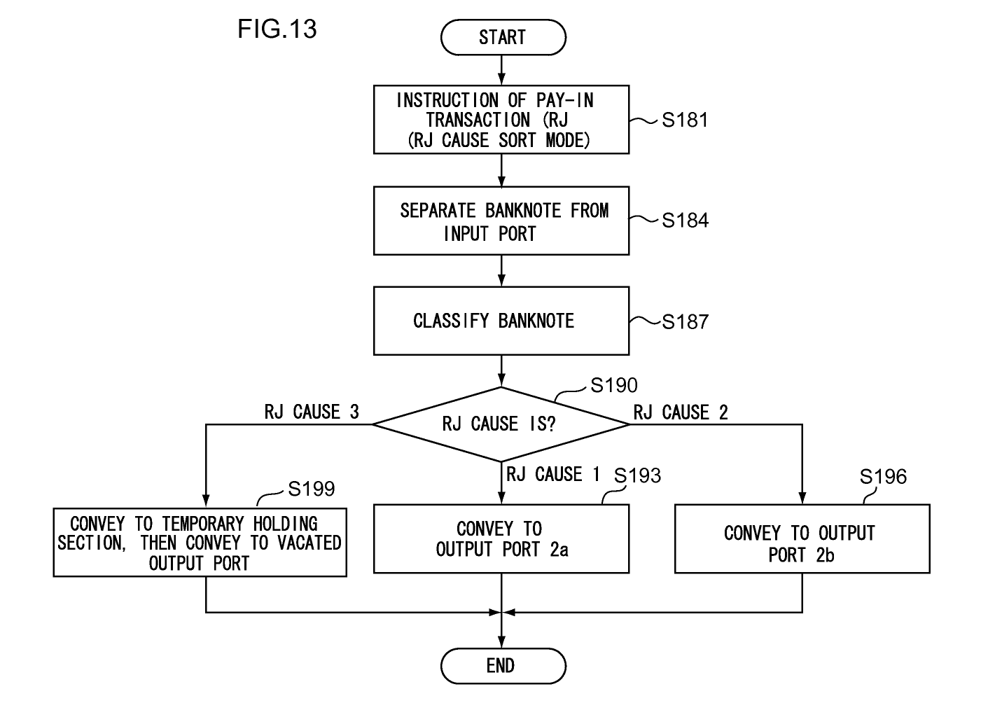

Explanation follows regarding the present exemplary embodiment, with reference to FIG. 13. FIG. 13 is a flow chart illustrating conveying processing of banknotes in the RJ cause sort mode of check counting operation, according to the sixth exemplary embodiment.

As illustrated in FIG. 13, first, at step S181, the RJ cause sort mode of check counting operation is instructed by the cashier. In the RJ cause sort mode, the cashier may instruct specific RJ causes that the cashier desires for determination. The cashier may also insert into the input port 1 rejected banknotes that have already been determined as to be rejected in a pay-in transaction or a check counting operation. This thereby enables rejected banknotes to be sorted more precisely by RJ cause.

Then, at step S184, the controller 11 effects control of separating, one note at a time, the banknotes stacked in the input port 1, and conveying the separated banknotes to the banknote classification section 4.

Then, the conveyed banknotes are classified (differentiated) at step S187 by the banknote identification section 4, and the specific RJ causes are determined. The specific RJ causes are, for example, RJ causes instructed by the cashier, and may be torn notes as RJ cause 1, abnormal travel as RJ cause 2, or other RJ causes as RJ cause 3.

Then, at step S190, the controller 11 effects conveyance control so as to dispense banknotes, out of those classified as abnormal by the banknote classification section 4, by specific RJ cause in the respective output ports 2a, 2b. For example, banknotes determined to be rejected by the banknote classification section 4 due to being torn (RJ cause 1), are conveyed to the output port 2a at step S193.

At step S190, the banknotes determined to be rejected by the banknote classification section 4 due to having abnormal travel (RJ cause 2), are conveyed at step S196 to the output port 2b.

At step S190, the banknotes determined to be rejected by the banknote classification section 4 due to other RJ causes (RJ cause 3), are conveyed to the temporary holding section 3 at step S199, and are then conveyed to a vacated output port from which banknotes have been collected, out of the plural output ports 2a, 2b.

As explained above, in the sixth exemplary embodiment, the RJ cause sort mode of the check counting operation enables the rejected banknotes to be respectively dispensed from the plural output ports 2a, 2b separately by reject cause. This thereby enables the cashier to discriminate the rejected banknotes according to RJ causes.

### 3-7. Seventh Exemplary Embodiment

In a seventh exemplary embodiment, the conveyance destination is selected from the output ports 2a, 2b according to the reception terminal 30 that is the source of instruction, and the banknotes are conveyed to the selected output port. In this way, even in cases in which there are plural cashiers each with a reception terminal 30 sharing a single banknote processing device 10, the banknotes are dispensed separately from respective output ports according to processing instructed from each of the reception terminals 30, and mistakes in collection of the dispensed banknotes between the cashiers may be prevented.

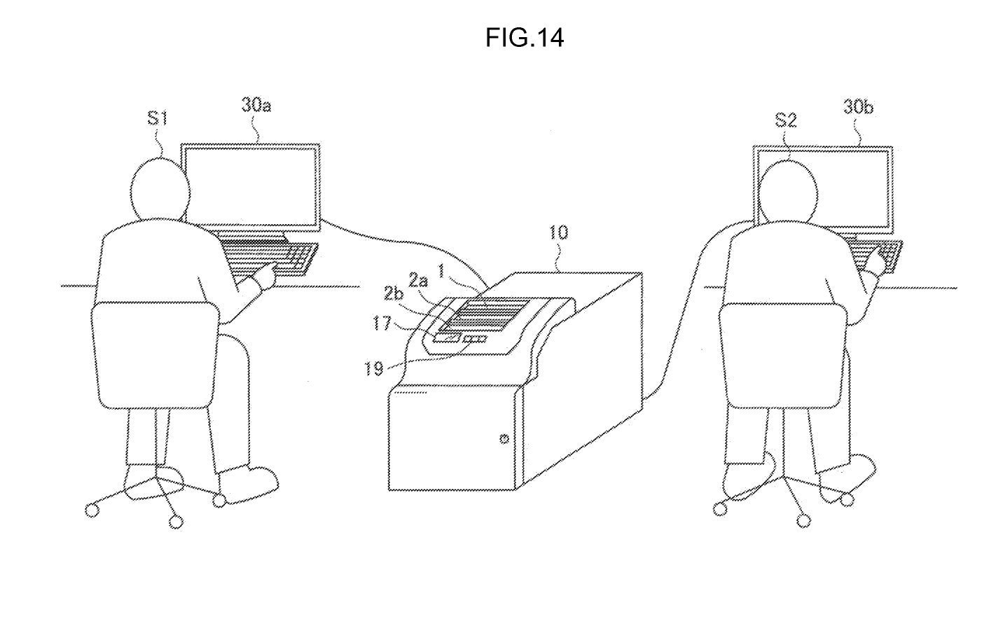

Explanation follows regarding sharing the banknote processing device 10 according to the present exemplary embodiment, with reference to FIG. 14. As illustrated in FIG. 14, in the present exemplary embodiment, plural reception terminals 30a, 30b are connected to the banknote processing device 10, and the banknote processing device 10 is disposed between the reception terminal 30a and the reception terminal 30b. A cashier S1 operating the reception terminal 30a and a cashier S2 operating the reception terminal 30b respectively send instructions from the reception terminals 30 they operate to the banknote processing device 10, such as for a pay-in or pay-out transaction, or check counting operation. The cashier S1 and the cashier S2 share the banknote processing device 10 by inserting banknotes into the banknote processing device 10 through the input port 1, and collecting banknotes from the output ports 2a, 2b.

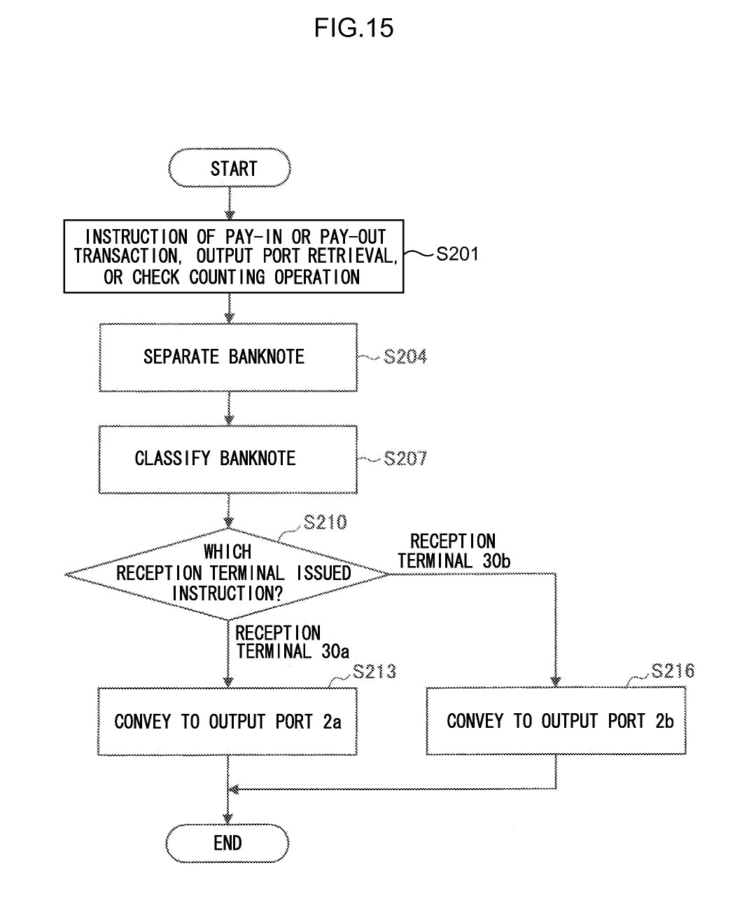

Explanation next follows regarding operation processing of the present exemplary embodiment, with reference to FIG. 15. FIG. 15 is a flow chart illustrating processing for dispensing banknotes according to the reception terminal, according to the seventh exemplary embodiment.

As illustrated in FIG. 15, first, at step S201, the reception terminal 30 is operated by the cashier, and the banknote processing device 10 receives an instruction from the reception terminal 30 for a pay-in or pay-out transaction, output port retrieval, or check counting operation.

Then, at step S204, the controller 11 effects control of separating the banknotes, one note at a time, from whichever of the input port 1, or the banknote cassettes 6A to 6D, according to the instruction contents, and conveying the separated banknotes to the banknote classification section 4.

Next, at step S207, the banknote classification section 4 classifies (differentiates) the conveyed banknote. Then, based on the classification result by the banknote classification section 4, the controller 11 effects control of conveying specific banknotes to specific conveyance destinations according to the processing currently being executed (pay-in or pay-out transaction, output port retrieval, or check counting operation). Note that the following explanation of steps subsequent to S210 illustrates conveying control during banknote dispensing.

At step S210, the controller 11 selects the output port for dispensing according to which of the reception terminals has instructed the processing currently being executed.

For example, if the processing currently being executed is processing instructed by the reception terminal 30a, at step S213 the controller 11 effects control so as to convey banknotes to dispense them from the output port 2a.

However, if the processing currently being executed is processing instructed by the reception terminal 30b, at step S216 the controller 11 effects control so as to convey banknotes to dispense them from the output port 2b.

Thus, since the cashier S1 who operates the reception terminal 30a collects banknotes that are dispensed from the output port 2a, and the cashier S2 who operates the reception terminal 30b collects banknotes that are dispensed from the output port 2b, mistaken collection of each other's banknotes is prevented.

As explained above, the seventh exemplary embodiment enables preventing mistaken collection of banknotes between cashiers by selectively dispensing banknotes from the output ports 2a, 2b according to the reception terminal issuing the instruction.

The seventh exemplary embodiment may also be combined with the first exemplary embodiment, such that banknotes are dispensed from the plural output ports 2a, 2b separately for each of the reception terminals issuing the instruction, and are dispensed in batches of a specific number of notes. More specifically, for example, banknotes may be dispensed in batches of 100 notes at the output port 2a in response to processing instructed from the reception terminal 30a, and banknotes may be dispensed in batches of 100 notes at the output port 2b in response to processing instructed from the reception terminal 30b. This thereby prevents cashiers from mistakenly collecting each other's banknotes, and facilitates determining the number of banknotes, further improving the convenience of the banknote processing device 10.

### 3-8. Eighth Exemplary Embodiment

### Varying Output Port Number

In the eighth exemplary embodiment, the convenience of the banknote processing device 10 is further improved by varying the physical or logical number of output ports selectable as the banknote conveyance destination as required. Explanation follows regarding plural specific examples of varying the number of output ports.

Degenerate Mode

Each of the above exemplary embodiments assumes that all of the plural output ports 2a, 2b are operating normally. However, a malfunction of any one of the output ports might occur. Thus, if a malfunction of an output port is detected, the controller 11 adopts a degenerate mode that prioritizes selection of output ports other than the output port for which malfunction has been detected, namely the output ports that are operating normally. This enables improvement in the availability of the banknote processing device 10.

Output Port Removal

Providing plural detachable output ports enables the physical number of output ports to be varied as required. For example, the number of output ports may be varied in advance according to the requirements of individual customers, when the banknote processing device 10 is being sold.

### 4. CONCLUSION

As explained above, according to the exemplary embodiment of the present invention, the convenience of the banknote processing device 10 can be improved by dispensing banknotes selectively from the plural output ports 2a, 2b.

More specifically, for example, dispensing banknotes from the plural output ports 2a, 2b in batches of a specific number of notes facilitates the cashier discriminating the number of banknotes.

Moreover, dispensing banknotes from the plural output ports 2a, 2b by denomination facilitates the cashier discriminating the denomination.

Moreover, dispensing banknotes from the plural output ports 2a, 2b according to the classification result of the banknote classification section 4 facilitates the cashier checking the banknotes.

Moreover, dispensing the banknotes from the plural output ports 2a, 2b according to the RJ cause of the banknote classification section 4 facilitates the cashier checking the banknotes.

Moreover, in a case in which the banknote processing device 10 is shared between plural reception terminals 30, dispensing banknotes selectively from the plural output ports 2a, 2b according to the reception terminal issuing the instruction may prevent cashiers from mistakenly collecting each other's banknotes.

Giving priority to the normal output ports to dispense banknotes when selecting an output port from the plural output ports may improve the availability of the banknote processing device 10.

Moreover, providing plural detachable output ports enables the number of output ports to be physically varied according to requirements.

Note that detailed explanation has been given regarding preferred exemplary embodiments of the present invention with reference to the attached drawings; however, the present invention is not limited to such examples. It would be clear to a practitioner skilled in the art that various modifications and alterations are possible within the range of the technical concepts recited in the scope of claims, and such modifications and alterations obviously fall within the technical scope of the present invention.

For example, a computer program may be produced to cause hardware such as a CPU, ROM, and RAM installed in the banknote processing devices 10 to perform an equivalent function to the controller 11 of the banknote processing devices 10 described above. A storage medium may also be provided that is stored with such a computer program.

Moreover, in the exemplary embodiments described above, explanation has been given in which the banknote processing devices 10 according to the present exemplary embodiment is applied to a staff-operated terminal; however, the banknote processing devices 10 of the present exemplary embodiment is not limited thereto. For example, the banknote processing devices 10 may be applied to a customer operated terminal, such as a cash processing section of an automatic transaction device typified by a banknote recirculating (recycling) Automated Teller Machine (ATM). Automatic transaction devices are installed at numerous locations such as in banks, at railway stations and in convenience stores. A customer may perform transactions such as pay-in transactions, pay-out transactions, and balance enquiries by performing various operations on a display screen displayed on the automatic transaction device.

1. A banknote processing device, comprising:
a plurality of dispensing ports that dispense banknotes;
a banknote classification section that classifies banknotes; and
a controller that selects a conveyance destination of banknotes classified by the banknote classification section from the plurality of dispensing ports, and effects control to convey the banknotes to a selected dispensing port.

2. The banknote processing device of claim 1, wherein the controller selects the conveyance destination of the banknotes from the plurality of dispensing ports according to the number of banknotes to be dispensed.

3. The banknote processing device of claim 1, wherein the controller selects the conveyance destination of the banknotes from the plurality of dispensing ports according to the denomination of banknotes to be dispensed.

4. The banknote processing device of claim 1, wherein:
the banknote classification section classifies the banknotes according to physical condition; and
the controller, during a check counting operation, selects the conveyance destination of the banknotes from the plurality of dispensing ports according to the physical condition of banknotes to be dispensed.

5. The banknote processing device of claim 1, wherein:
the banknote classification section classifies the banknotes according to authenticity; and
the controller, during a check counting operation, selects the conveyance destination of the banknotes from the plurality of dispensing ports according to the authenticity of banknotes to be dispensed.

6. The banknote processing device of claim 1, wherein:
the banknote classification section classifies the banknotes according to a cause of rejection; and
the controller, during a check counting operation, selects the conveyance destination of the banknotes from the plurality of dispensing ports according to the cause of rejection of banknotes to be dispensed.

7. The banknote processing device of claim 1, wherein:
the banknote classification section classifies the banknotes according to authenticity and physical condition; and
the controller, during a pay-in transaction, effects conveyance control to deliver banknotes classified by the banknote classification section as normal to a banknote storage section, and to deliver banknotes classified by the banknote classification section as counterfeit notes or damaged notes to a conveyance destination selected from the plurality of dispensing ports in accordance with the classification result.

8. The banknote processing device of claim 1, wherein the controller effects conveyance control so as to utilize a dispensing port other than a dispensing port detected to have a malfunction, if one or more dispensing ports of the plurality of dispensing ports have been detected to have a malfunction.

9. The banknote processing device of claim 1, wherein the plurality of dispensing ports are detachable.

10. The banknote processing device of claim 1, wherein:
the banknote processing device is connected to a plurality of reception terminals; and
the controller receives instructions for a pay-in or pay-out transaction, a check counting operation, or a dispensing port retrieval operation from the plurality of reception terminals, and selects the conveyance destination of the banknotes from the plurality of dispensing ports in accordance with the reception terminal from which the instructions have been received.
